(19) United States
(12) Patent Application Publication
(10) Pub. No.: US 2011/0239008 A1
(43) Pub. Date: Sep. 29, 2011

(54) Power Adapter Having a Universal Serial Bus Hub

(76) Inventors: Kean W. Lam, Richmond Hill (CA); Richard W. Teltz, Hamilton (CA); Fang Hua, Hamilton (CA)

(21) Appl. No.: 13/070,743

(22) Filed: Mar. 24, 2011

Related U.S. Application Data
(60) Provisional application No. 61/318,031, filed on Mar. 26, 2010.

(51) Int. Cl. G06F 1/26

(52) U.S. Cl. 713/300

(57) ABSTRACT

A power adaptor for a host device and method of operating the same. In one embodiment, the power adapter includes a power converter and a universal serial bus hub. The power adapter also includes an integrated power/universal serial bus connector, coupled to the power converter and the universal serial bus hub, configured to provide power to and universal serial bus communication with a host device.

This application claims the benefit of U.S. Provisional Application No. 61/318,031, entitled “Power Adapter Having a Universal Serial Bus Hub,” filed on Mar. 26, 2010, which application is incorporated herein by reference.

### TECHNICAL FIELD

The present invention is directed, in general, to power electronics and, more specifically, to a power adapter including a power converter and a universal serial bus hub and method of operating the same.

### BACKGROUND

A switched-mode power converter (also referred to as a “power converter” or “regulator”) is a power supply or power processing circuit that converts an input voltage waveform into a specified output voltage waveform. Ac-dc power converters convert an alternating current (“ac”) input voltage into a dc output voltage. Dc-dc power converters convert a direct current (“dc”) input voltage into a dc output voltage. A power converter with a low power rating designed to convert an alternating current mains voltage or a direct current voltage source to a dc output voltage to power an electronic load such as a printer, personal computer, or other portable electronic device such as a wireless communication device is generally referred to as a “power adapter,” also referred to as an “adapter.” In general, an adapter may be powered from an ac or a dc power source.

As portable computing and wireless communication needs have continued to rapidly expand, it has become important to provide a high level of functional capabilities in a lightweight package that is thin and robust for the application environment. However, as portable devices such as personal computers are pushed to thinner and lighter designs, it has become increasingly difficult to support the complete range of accessory components such as power adapters, universal serial bus (“USB”) hubs, disk drives, and wireless transceivers found in full-featured personal computers today. Each of these accessories is generally not required for a particular task and, as a result, a substantial number of peripheral devices are typically unremovably transported with the basic functional features of the personal computer or other device. Nonetheless, to enable thin and light designs of a portable computing device such as a portable personal computer or wireless communication device, it has become common practice to construct the adapter as a separate device that is coupled to the personal computer with a cable.

Despite continued reduction in size and processing capability of integrated digital devices to meet increasing market demands, no satisfactory strategy has emerged to enable further reduction in size and weight of portable personal computers or wireless communication devices, and that can be advantageously adapted to high-volume manufacturing techniques. Accordingly, what is needed in the art is a design approach and related method for a power adapter that enables further reduction of in size of host devices such as portable personal computers, wireless communication devices or the like.

### SUMMARY OF THE INVENTION

These and other problems are generally solved or circumvented, and technical advantages are generally achieved, by advantageous embodiments of the present invention, including a power adaptor and method of operating the same. In one embodiment, the power adapter includes a power converter and a universal serial bus hub. The power adapter also includes an integrated power/universal serial bus connector, coupled to the power converter and the universal serial bus hub, configured to provide power to and universal serial bus communication with a host device.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, reference is now made to the following descriptions taken in conjunction with the accompanying drawings, in which:

FIGS. 1A and 1B illustrate an end view and a side view, respectively, of an embodiment an integrated power/USB connector for a power adapter constructed according to the principals of the present invention;

FIGS. 2 to 4 illustrates perspective views of embodiments of integrated power/USB connectors for a power adapter constructed according to the principals of the present invention;

FIG. 5 illustrates a cross sectional view of an embodiment of a cable of a power adapted constructed according to the principles of the present invention;

FIGS. 6 and 7 illustrate perspective views of embodiments of portions of power adapters constructed according to the principles of the present invention;

FIG. 8 illustrates a schematic diagram of an embodiment of a power adapter constructed according to the principles of the present invention; and

FIG. 9 illustrates a block diagram of an embodiment of a power adapter including an integrated power/USB connector and a cable constructed according to the principles of the present invention.

Corresponding numerals and symbols in the different figures generally refer to corresponding parts unless otherwise indicated, and may not be redescribed in the interest of brevity after the first instance. The FIGUREs are drawn to illustrate the relevant aspects of exemplary embodiments.

### DETAILED DESCRIPTION OF ILLUSTRATIVE EMBODIMENTS

The making and using of the present exemplary embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to exemplary embodiments in a specific context, namely, a power adapter configured to provide USB-enabled capabilities as separate from a host device such as a portable personal computer or wireless communication device. While the principles of the present invention will be described in the environment of a power adapter, any application that may benefit from a power adapter with USB-enabled capabilities including a power amplifier or a motor controller is well within the broad scope of the present invention.

In accordance therewith, an integrated power/USB cable and connector provides both dc power from, and USB communication with, a power converter and USB hub of the power adapter to a host device. The USB-enabled power adapter including the integrated power/USB cable and connector allows peripheral devices such as a USB hub, a disk drive, camera, and a wireless transceiver to be offloaded from a host device such as a portable personal computer or wireless communication device, thus reducing its size, weight, and base cost of the host device. Users generally travel with a power adapter separate from the host device, thereby providing access to these capabilities when traveling.

The USB-enabled power adapter introduced herein features both a power converter to power a portable personal computer or other device and charge its battery, and the ability to support USB devices that are attached to, integrated into, or are located separately from the power adapter. This allows peripheral devices to be relocated from the host device to the power adapter, resulting in a smaller, lighter, and lower cost personal computer, while still supporting a broad computing and communication feature set. Since most users travel with the power adapter, the users will still have access to all of the features. The USB-enabled power adapter can also support components that are too large to fit into standard portable personal computers, or do not have a large enough attach rate to justify including the same as configure-to-order/build-to-order (“CTO/BTO”) options.

The USB-capable components (also referred to as USB devices) can accordingly be moved from the personal computer to the USB-enabled power adapter, reducing the base cost of the personal computer, reducing the physical size, and giving users flexibility with respect to system functionality. A USB hub is either completely integrated into the USB-enabled power adapter housing or made detachable, allowing users to dynamically reconfigure the functionality of the host device such as a personal computer by swapping USB devices with respect to the USB-enabled power adapter.

The USB functionality in the USB-enabled power adapter, such as supporting USB hubs, added memory, etc., is enabled using an integrated power/USB cable and connector. The USB functionality may also be extended to provide a highly integrated interface with the power functionality of the USB-enabled power adapter such as fault reporting and controlling an operational mode of the USB-enabled power adapter for the host device such as a personal computer including an idle or sleep mode. The integrated power/USB cable is formed with an integrated power/USB connector that can be arranged to be compatible with various existing host device power connectors. A removable adapter tip can be used to connect the USB-enabled power adapter to a standard power connector of the host device.

The power adapters currently used with personal computers often use three leads or wires, namely, a high voltage lead such as a +19 volt (“V”) dc lead, a ground/return lead, and a power supply identification (“PSID”) lead to synchronize the adapter circuitry with the host device charging and power management subsystem. It is recognized that a PSID lead may not be used by all presently available host devices. The USB-enabled power adapter introduced herein adds additional leads to support USB communication, namely, a differential pair for USB signals and two leads for USB power. Accordingly, the two leads in the cable for USB power may be employed to power USB functionality in the USB-enabled power adapter from power supplied by the battery of the host device when the USB-enabled power adapter is not plugged into an ac mains outlet. Additionally, the combined power/USB connector is integrated into a single plug and connector combination that is compatible with standard host device adapters, thereby reducing desktop clutter. A removable power tip can be used to adapt a power plug to fit into a standard host device power connector.

In an embodiment, the integrated power/USB connector to the host device is implemented with a “Y-cable” in which the integrated power/USB cable is divided into separate data/USB and power connections at the host device end. The dc power connection may use standard host device connectivity, while the USB hub in the USB-enabled power adapter may plug into one of the standard host device USB connections.

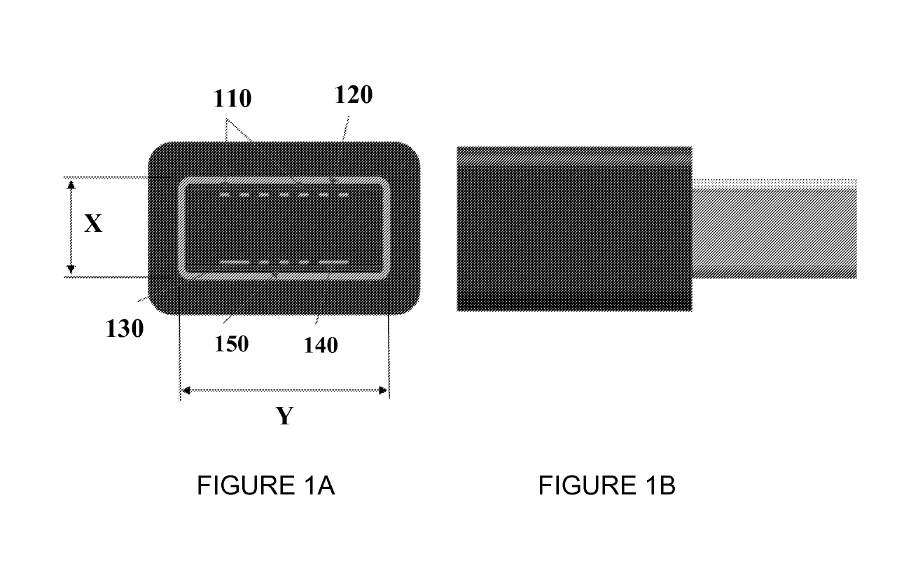

Turning now to FIGS. 1A and 1B, illustrated are an end view and a side view, respectively, of an embodiment an integrated power/USB connector for a power adapter constructed according to the principals of the present invention. The integrated power/USB connector includes five connectors (collectively designated 110) in an upper row to provide audio and USB communication connectivity. In addition, two unused connectors (collectively designated 120) are included in the upper row that may be used at a later time to provide additional functionality. In a lower row, one connector (designated 130) is used to provide dc power for a host device such as a personal computer (e.g., +19 volt (“V”) at 5 amperes (“A”) or +12 V at 5 A). Another connector (designated 140) is employed to provide dc ground (i.e., a return current path) for the dc power. FIG. 1 also illustrates three additional unused connectors (collectively designated 150) in the lower row that may be used at a later time for additional functionality. Exemplary dimensions of the integrated power/USB connector are X=4.2 millimeters (“mm”) and Y=8.6 mm.

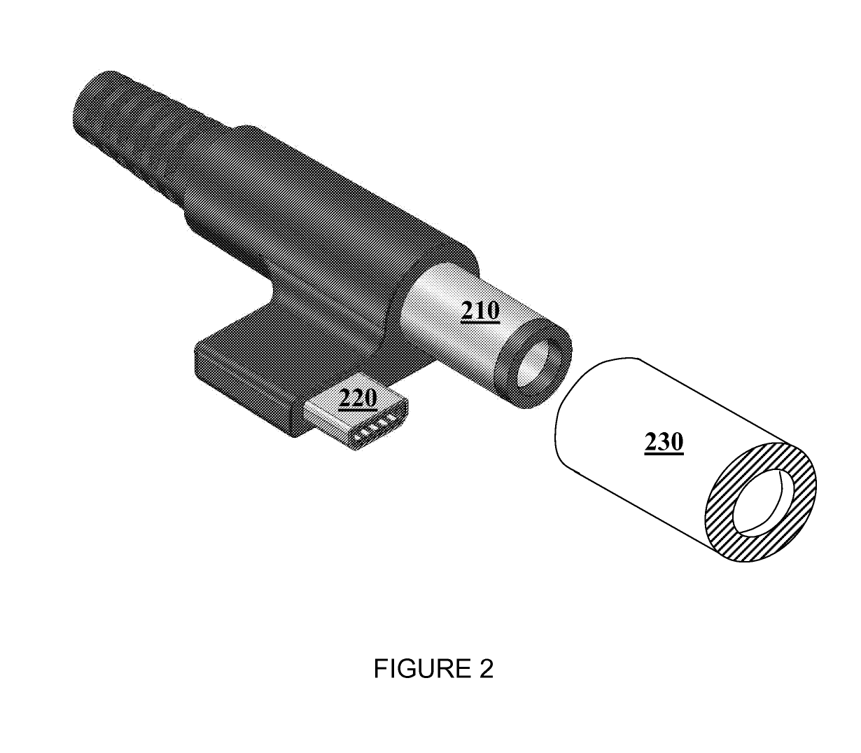

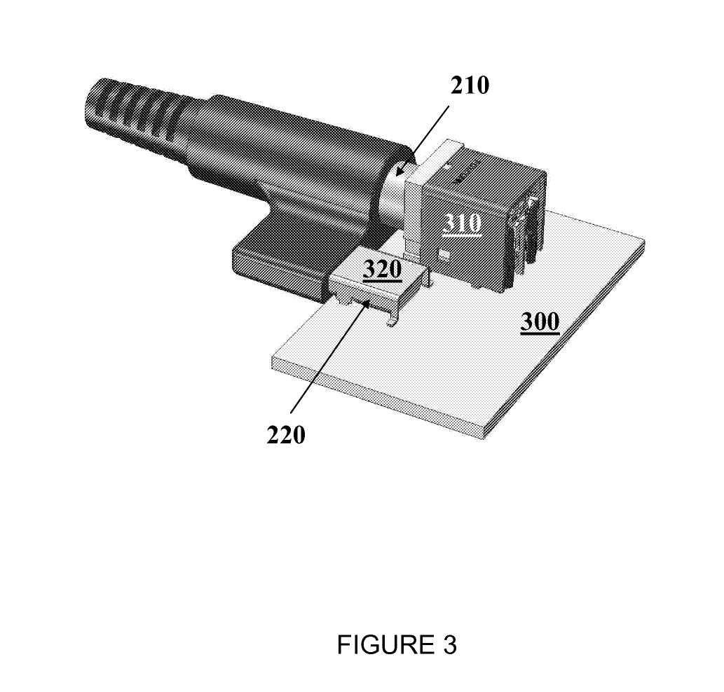

Turning now to FIGS. 2 to 4, illustrated are perspective views of embodiments of integrated power/USB connectors for a power adapter constructed according to the principals of the present invention. Beginning with FIG. 2, the integrated power/USB connector is formed with a dc power connector 210 (e.g., having a barrel end) integrated with a USB connector 220. Depending on the design and location of the connector for the host device (e.g., the personal computer), the integrated power/USB connector can be positioned so that the dc power connector 210 engages the corresponding connector of the personal computer. A removable adapter tip 230 may be employed to extend the reach of the dc power connector 210 so that it may coupled to a wider range of personal computer designs that might otherwise be obstructed by the presence of the USB connector 220. Regarding FIG. 3, the integrated power/USB connector of FIG. 2 is inserted into mating connectors 310, 312, respectively, of a printed wiring board 300 that may be located inside a host device such as a personal computer or other device.

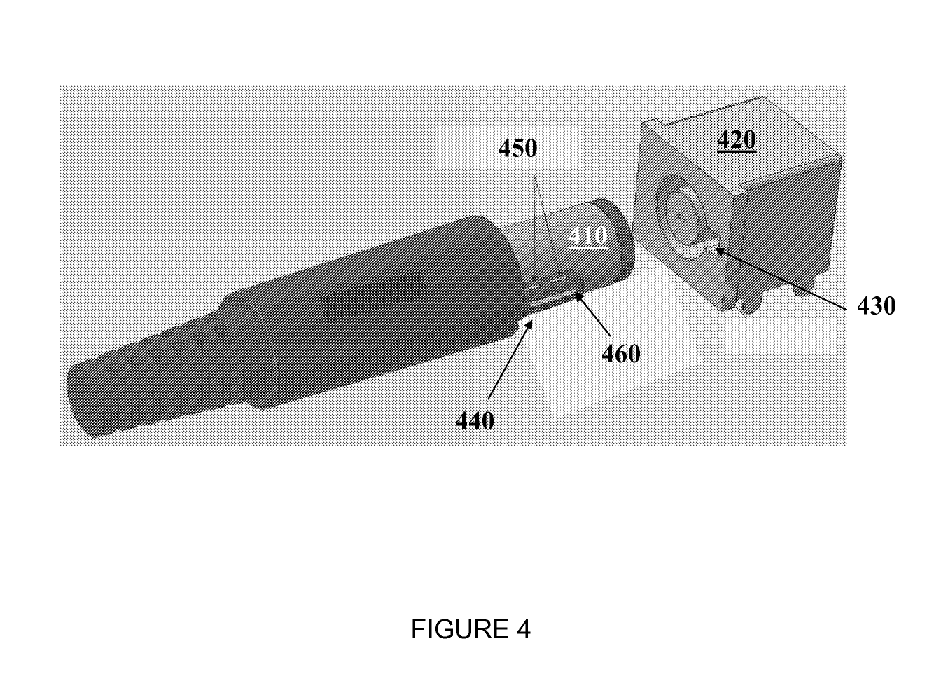

Turning now to FIG. 4, illustrated is a perspective view of another embodiment of an integrated power/USB connector for a power adapter constructed according to the principles of the present invention. The keyed integrated power/USB connector includes a barrel end 410 for connection to a mating keyed connector 420 formed with key slot 430 (e.g., 8.5 mm circumference). The USB functionality is built into a key by providing connectors to allow the keyed integrated power/USB connector to support current power barrel connectors. A key 440 located on the side of the barrel end 410 is formed with two USB connectors (or contacts) 450 on one side of the key 440, and two USB connectors (hidden from view) on an opposing side of the key 440. An additional connector 460 may be formed on the lateral exposed side of the key 440 to provide additional functionality. By forming the key 440 on only a portion of the barrel end 410, the integrated power/USB connector can be inserted into a standard mating keyed connector 420. Thus, the upgraded functional capability of the keyed integrated power/USB connector can be provided to an end user on an optional basis.

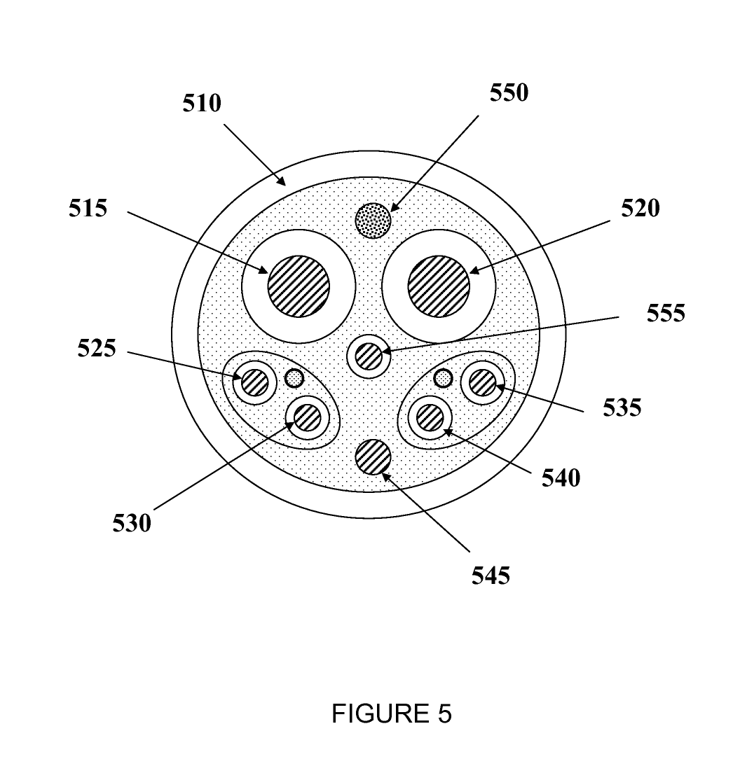

Turning now to FIG. 5, illustrated is a cross sectional view of an embodiment of a cable of a power adapted constructed according to the principles of the present invention. The cable is located between a power converter and USB hub, and an integrated power/USB connector of the USB-enabled power adapter. The cable includes an insulating sheath 510 about a periphery thereof. The cable is formed with dc power lead 515 and return ground lead 520 that would each be typically formed with 20 American wire gauge (“AWG”) wire. The cable further includes a first shielded USB differential pair leads 525, 530 formed with 28 AWG wires, and a second shielded USB differential pair leads 535, 540 formed with 28 AWG wires. The cable further includes an anti-static drain lead 545 to bleed static electrical charge from the cable. The cable may also be formed with a nonconductive filler 550 to provide mechanical support for the insulating sheath 510. A ground lead 555 is also included to provide a general ground connection between local circuit ground of the power adapter and local circuit ground of the host device such as a personal computer or other device.

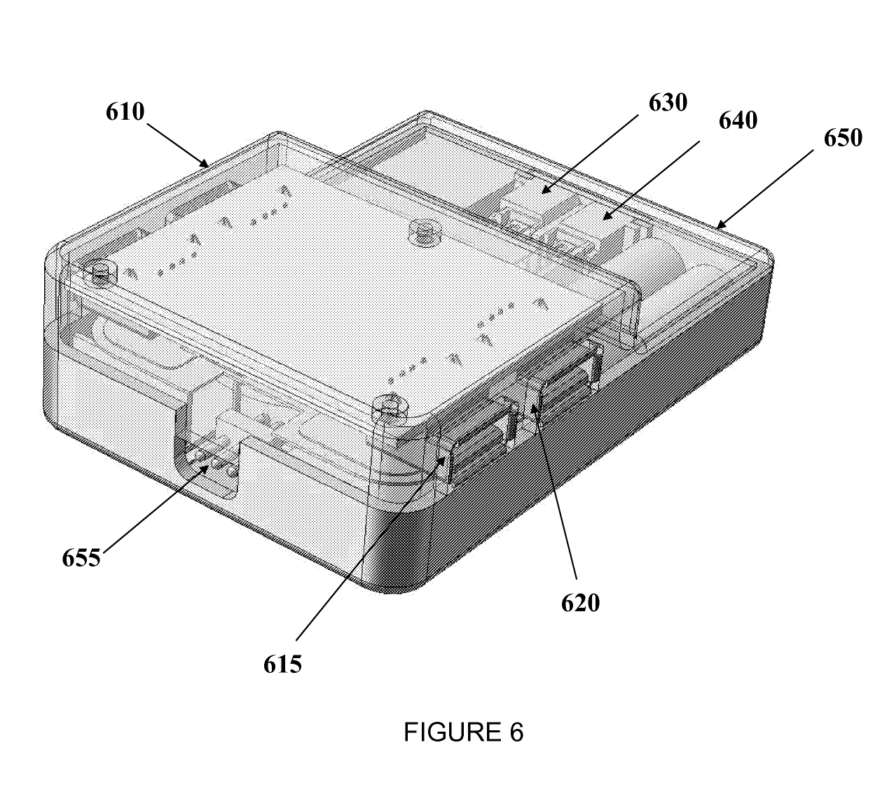

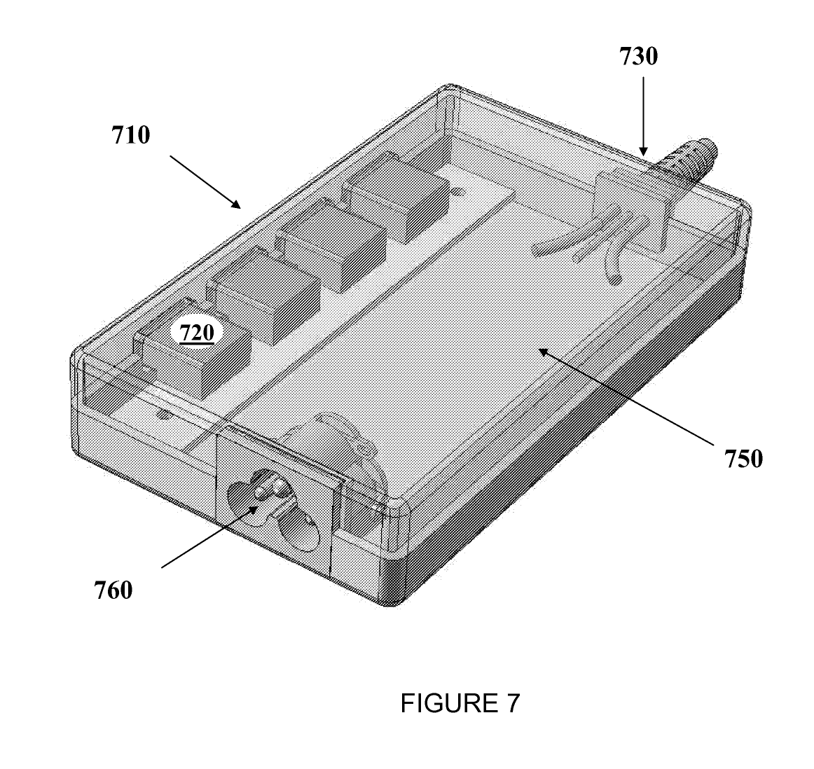

Turning now to FIGS. 6 and 7, illustrated are perspective views of embodiments of portions of power adapters (e.g., USB-enabled power adapters) constructed according to the principles of the present invention. The USB-enabled power adapter of FIG. 6 includes a USB hub 610 (e.g., a four-port powered/unpowered USB hub) and an ac-dc power converter 650 (e.g., a FlexPower S90). The USB hub 610 includes USB connectors 615, 620 for connection to a USB device. The ac-dc power converter 650 includes an ac power connector 655 configured to receive a cable to provide power to the ac-dc power converter 650 from a source of electrical power such as an ac mains. The USB-enabled power adapter further includes power/USB ports 630, 640 configured to provide safety-rated dc power/USB connectivity, respectively, to a cable (see, e.g., the cable described with respect to FIG. 5) and an integrated power/USB connector (see, e.g., the integrated power/USB connectors described with respect to FIGS. 2 to 4) for a host device. Thus, the USB-enabled power adapter is configured to provide dc power for a host device such as a personal computer as well as a remote USB hub 610 that may be removably detached from the personal computer, thereby eliminating the need for a USB and its associated connectors to be installed in the personal computer.

The USB-enabled power adapter of FIG. 7 includes a USB hub 710 (e.g., a four-port powered/unpowered USB hub) and an ac-dc power converter 750 (e.g., a FlexPower slim form factor power adapter). The USB hub 710 includes USB connectors (one of which is designated 720) for connection to a USB device. The ac-dc power converter 750 includes an ac power connector 760 configured to receive a cable to provide power to the ac-dc power converter 750 from a source of electrical power such as an ac mains. The USB-enabled power adapter further includes a power/USB port 730 configured to provide safety-rated dc power/USB connectivity, respectively, to a cable (see, e.g., the cable described with respect to FIG. 5) and an integrated power/USB connector (see, e.g., the integrated power/USB connectors described with respect to FIGS. 2 to 4) for a host device.

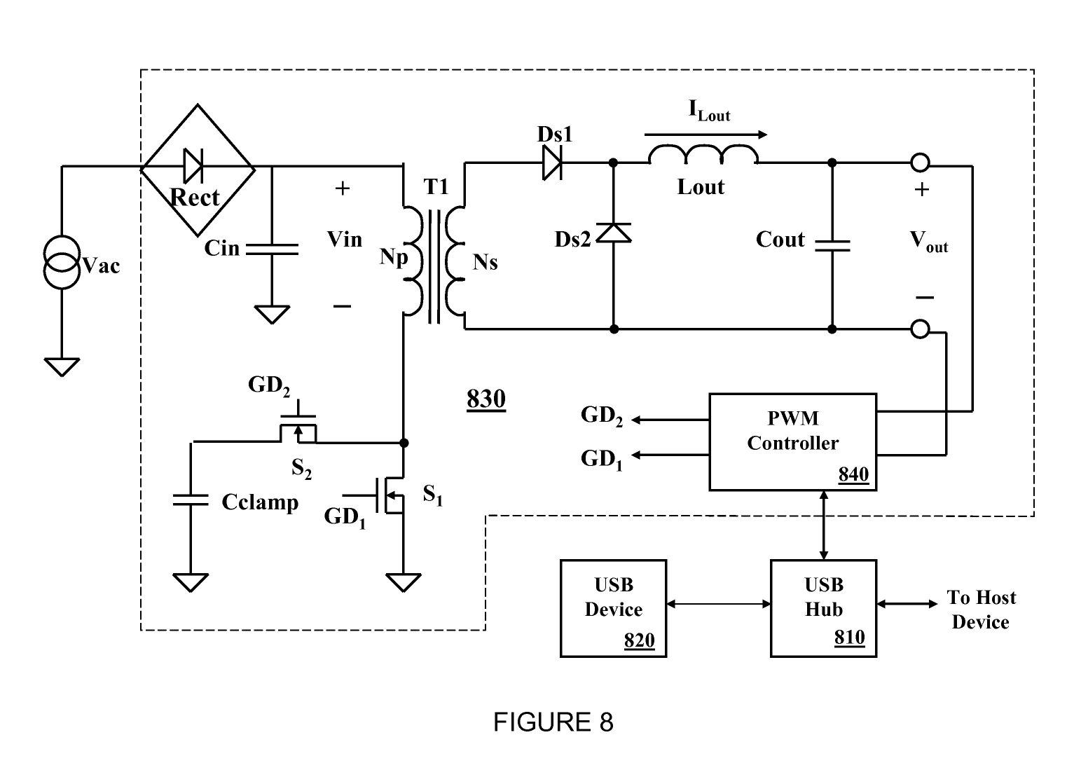

Turning now to FIG. 8, illustrated is a schematic diagram of an embodiment of a power adapter (e.g., a USB-enabled power adapter) constructed according to the principles of the present invention. The USB-enabled power adapter includes a USB hub 810 that provides connectivity via a cable and integrated power/USB connector to a host device such as a personal computer notebook computer. The USB-enabled power adapter further includes a USB device 820 (e.g., a USB-enabled disk drive, a USB-enabled flash memory device, a USB-enabled camera) coupled to the USB hub 810. Of course, the USB device 820 may be removably detached from the USB hub 810 or be integrated into the overall power adapter, thereby offering a multi-purpose, integrated device.

The USB-enabled power adapter further includes a power converter 830 including an active clamp forward power train. Of course, the power converter 830 may employ other topologies such as, without limitation, a flyback power train. The power converter 830 is coupled to a source of electrical power (e.g., an input power source such as the ac mains) represented by an input voltage Vac. In an alternative embodiment, the input voltage to the USB-enabled power can be provided by a dc voltage source. The input voltage Vac is rectified by diode bridge rectifier Rect and filtered by filter capacitor Cin to form a dc input voltage Vin. The dc input voltage Vin supplies input power to an isolating transformer or transformer T1. The transformer T1 has a primary winding with primary turns Np and a secondary winding with secondary turns Ns that are selected to provide an output voltage Vₒᵤₜ with consideration of a resulting duty cycle and stress on power train components. A power train of the power converter 830 includes first and second power switches S₁, S₂ coupled to the input power source that provides the input voltage Vin. The first power switch S₁ (e.g., an n-channel metal-oxide semiconductor field-effect transistor (“MOSFET”)) is controlled by a controller such as a pulse-width modulation (“PWM”) controller 840 that controls the first power switch S₁ to be conducting for a duty cycle D. The second power switch S₂ (a reset switch such as an n-channel MOSFET) is coupled to a clamp capacitor Cclamp and to the first power switch S₁. The second power switch S₂ is controlled to conduct for a substantially complementary duty cycle 1-D.

Thus, the first and second power switches S₁, S₂ conduct alternately with a switching frequency fₛ in response to gate drive signals GD₁, GD₂, respectively, produced by the PWM controller 840. The duty cycle D is adjusted by the PWM controller 840 to regulate a characteristic of the output of the power converter 830 such as output voltage Vₒᵤₜ, an output current, or a combination of the two. An ac voltage appearing on the secondary winding of the transformer T1 is rectified by a forward diode Ds1 and a freewheeling diode Ds2, and the dc component of the resulting waveform is coupled to the output through a low-pass output filter including an output filter inductor Lout and an output filter capacitor Cout to produce the output voltage Vₒᵤₜ.

During the first portion of a duty cycle D, an inductor current I_{Lout} flowing through the output filter inductor Lₒᵤₜ increases as current flows from the input to the output of the power converter. During a complementary portion of the duty cycle (generally co-existent with a complementary duty cycle “1-D” of the first power switch S₁), the first power switch S₁ is transitioned to a non-conducting state and the second power switch S₂ coupled to the output filter inductor Lₒᵤₜ is enabled to conduct in response to the gate drive signal GD₂. The second power switch S₂ provides a path to maintain a continuity of the inductor current I_{Lout} flowing through the output filter inductor Lₒᵤₜ. During the complementary portion of the complimentary duty cycle 1-D, the inductor current I_{Lout} flowing through the output filter inductor Lₒᵤₜ decreases. In general, during the first portion of the duty cycle D, the duty cycle of the first and second power switches S₁, S₂ may be adjusted to maintain a regulation of the output voltage Vₒᵤₜ of the power converter. Those skilled in the art should understand, however, that the conduction periods for the first and second power switches S₁, S₂ may be separated by a small time interval to avoid cross conduction therebetween and beneficially to reduce the power switching losses associated with the power converter. In addition, the PWM controller 840 may include or be coupled to an isolation device such as a pulse transformer or an opto-isolator to provide metallic isolation between the primary and secondary sides of the power converter.

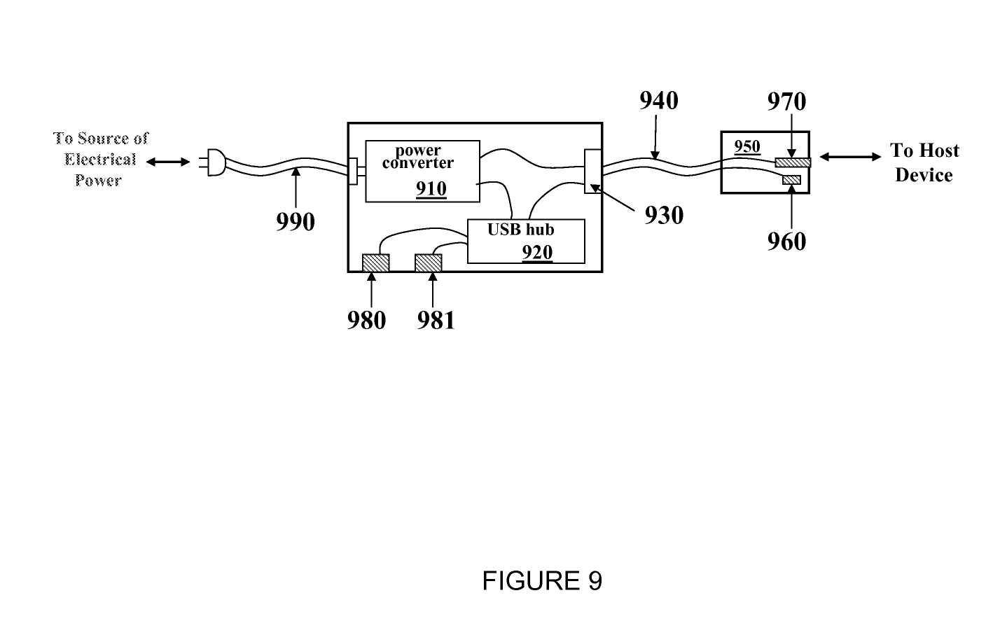

Turning now to FIG. 9, illustrated is a block diagram of an embodiment of a power adapter including an integrated power/USB connector 950 and a cable 940 constructed according to the principles of the present invention. The cable 940 is coupled to the USB-enabled power adapter through power/USB port 930. The USB-enabled power adapter includes a power converter 910 and a USB hub 920. The USB-enabled power adapter further includes USB connectors 980, 981 that are configured to accept a conventional USB cable that may be coupled to USB-enabled devices such as a flash-memory device, a wireless adapter, or a further USB hub. The USB-enabled power adapter is configured to be coupled to a source of electrical power such as ac mains power over power cable 990. The integrated power/USB connector 950 is configured to be coupled to a host device such as a personal computer or a server, and is formed with a USB connector 960 and a power connector 970 as described previously hereinabove with reference to FIGS. 2 to 4. In the absence of a source of electrical power that may be coupled to the power cable 990, power for the USB-enabled power adapter may be supplied by the power connector 970 coupled to the host device.

Thus, a USB-enabled power adapter is constructed to provide dc input power to a host device and USB functionality for devices external to the host device. In this manner, substantial space and cost are saved in constructing the host device, enabling the use of a more convenient host device in a portable environment.

In one embodiment, the USB-enabled power adapter includes a power converter, a universal serial bus (“USB”) hub, and a cable having leads from the power converter and the USB hub to an integrated power/USB connector for connection to a host device (e.g., a personal computer or a wireless communication device). The USB-enabled power adaptor includes an ac power connector configured to receive a cable to provide power to the power converter from a source of electrical power. The USB-enabled power adapter may also include a power/USB port from the power converter and the USB hub to the cable. Regarding the cable, ones of the leads provide power from the power converter to the host device via a power connector of the integrated power/USB connector, and ones of the leads provide USB communication between the USB hub and the host device via a USB connector of the integrated power/USB connector. The cable may also include an insulating sheath about a periphery thereof, a power lead and return ground lead, first and second shielded USB differential pair leads, an anti-static drain lead, a nonconductive filler and a ground lead. Regarding the integrated power/USB connector, the connector may include a power connector having a barrel end and a removable adapter tip configured to extend a reach of the power connector to the host device. The integrated power/USB connector may also include a power connector having a barrel end and a key located on a side thereof with at least one USB connector located on a side of the key. The power converter of the USB-enabled power adaptor may include a bridge rectifier, an active clamp forward power train and a controller.

Those skilled in the art should understand that the previously described embodiments of a power adapter configured to provide USB-enabled capabilities and related methods of operating the same are submitted for illustrative purposes only. While a power adapter configured to provide USB-enabled capabilities has been described in the environment of a power converter for a portable computer or wireless communication device, these processes may also be applied to other systems such as, without limitation, a power amplifier or a motor controller

For a better understanding of power converters, see “Modern DC-to-DC Power Switch-mode Power Converter Circuits,” by Rudolph P. Severns and Gordon Bloom, Van Nostrand Reinhold Company, New York, N.Y. (1985) and “Principles of Power Electronics,” by J. G. Kassakian, M. F. Schlecht and G. C. Verghese, Addison-Wesley (1991).

Also, although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A power adapter, comprising:
a power converter;
a universal serial bus (“USB”) hub; and
an integrated power/USB connector, coupled to said power converter and said USB hub, configured to provide power to and USB communication with a host device.

2. The power adapter as recited in claim 1 wherein said host device comprises a personal computer or a wireless communication device.

3. The power adapter as recited in claim 1 further comprising at least one USB connector on said power adapter.

4. The power adapter as recited in claim 1 further comprising an ac power connector configured to receive a power cable to provide power to said power converter from a source of electrical power.

5. The power adapter as recited in claim 1 further comprising a power/USB port configured to couple said power converter and said USB hub via a cable to said integrated power/USB connector.

6. The power adapter as recited in claim 5 wherein ones of leads of said cable provide power from said power converter to said host device via a power connector of said integrated power/USB connector, and ones of leads of said cable provide USB communication between said USB hub and said host device via a USB connector of said integrated power/USB connector.

7. The power adapter as recited in claim 6 wherein said power connector comprises a barrel end and a removable adapter tip configured to extend a reach of said power connector to said host device.

8. The power adapter as recited in claim 6 wherein said power connector comprises a barrel end and a key located on a side thereof and at least one USB contact located on a side of said key.

9. The power adapter as recited in claim 5 wherein said cable comprises an insulating sheath about a periphery thereof, a power lead and return ground lead, first and second shielded USB differential pair leads, an anti-static drain lead, a nonconductive filler and a ground lead.

10. The power adapter as recited in claim 1 wherein said power converter comprises a bridge rectifier, an active clamp forward power train and a controller.

11. A method, comprising:
providing power via a power converter;
providing universal serial bus (“USB”) communication with a USB hub; and
providing said power and said USB communication from said power converter and said USB hub, respectively, to a host device via an integrated power/USB connector.

12. The method as recited in claim 11 wherein said host device comprises a personal computer or a wireless communication device.

13. The method as recited in claim 11 further comprising receiving a USB-enabled device via a USB connector.

14. The method as recited in claim 11 further comprising providing power to said power converter from a source of electrical power.

15. The method as recited in claim 11 further comprising coupling said power converter and said USB hub via a cable to said integrated power/USB connector.

16. The method as recited in claim 15 wherein ones of leads of said cable provide power from said power converter to said host device via a power connector of said integrated power/USB connector, and ones of leads of said cable provide USB communication between said USB hub and said host device via a USB connector of said integrated power/USB connector.

17. The method as recited in claim 16 further comprising extending a reach of said power connector to said host device with a removable adapter tip coupled to a barrel end of said power connector.

18. The method as recited in claim 16 wherein said power connector comprises a barrel end and a key located on a side thereof and at least one USB contact located on a side of said key.

19. The method as recited in claim 15 wherein said cable comprises an insulating sheath about a periphery thereof, a power lead and return ground lead, first and second shielded USB differential pair leads, an anti-static drain lead, a nonconductive filler and a ground lead.

20. The method as recited in claim 11 wherein said power converter comprises a bridge rectifier, an active clamp forward power train and a controller.
